(19) United States
(12) Patent Application Publication
(10) Pub. No.: US 2017/0184157 A1
(43) Pub. Date: Jun. 29, 2017

(54) DRIVE FORCE TRANSFER DEVICE

(71) Applicant: JTEKT CORPORATION, Osaka-shi (JP)

(72) Inventors: Noriyuki FUJII, Hekinan-shi (JP); Hiroshi TAKUNO, Nukata-gun (JP); Yutaka MURAKOSHI, Shizuoka-shi (JP); Yohei FUJII, Kariya-shi (JP)

(73) Assignee: JTEKT CORPORATION, Osaka-shi (JP)

(21) Appl. No.: 15/388,469

(22) Filed: Dec. 22, 2016

(30) Foreign Application Priority Data
Dec. 25, 2015 (JP) 2015-254502

(51) Int. Cl. F16D 48/02; B60K 17/02; B60K 17/34; F16D 13/52

(52) U.S. Cl. CPC F16D 25/14; F16D 13/52; B60K 17/02; B60K 17/34

(57) ABSTRACT

A drive force transfer device that includes a friction clutch with improved response at the time when the friction clutch is pressed by a hydraulic pressure is provided. A drive force transfer device has: a clutch drum; an inner shaft; a friction clutch that has a plurality of outer clutch plates that are rotatable together with the clutch drum and a plurality of inner clutch plates that are rotatable together with the inner shaft; a piston that receives a hydraulic pressure supplied to a cylinder to press the friction clutch; and a hydraulic circuit that supplies the cylinder with working oil. The hydraulic circuit has a first pump portion that supplies the cylinder with the working oil, and a second pump portion that supplies the cylinder with the working oil at a pressure that is higher than that of the working oil supplied by the first pump portion.

### INCORPORATION BY REFERENCE

The disclosure of Japanese Patent Application No. 2015-254502 filed on Dec. 25, 2015 including the specification, drawings and abstract, is incorporated herein by reference in its entirety.

### BACKGROUND OF THE INVENTION

1. Field of the Invention

The present invention relates to a drive force transfer device that transfers a drive force between rotary members.

2. Description of the Related Art

There has hitherto been four-wheel-drive vehicles which include a pair of right and left main drive wheels and a pair of right and left auxiliary drive wheels and in which a drive force of a drive source is always transferred to the main drive wheels and the drive force of the drive source is transferred to the auxiliary drive wheels only during four-wheel drive. In some of such four-wheel-drive vehicles, the auxiliary drive wheels are driven by a drive force (torque) transferred via a friction clutch that is pressed by a hydraulic pressure (see Japanese Patent Application Publication No. 2014-231858 (JP 2014-231858 A), for example).

A four-wheel-drive vehicle described in JP 2014-231858 A includes a drive force distribution device that distributes a drive force to a pair of right and left auxiliary drive wheels. The drive force distribution device includes: a pump that discharges working oil; a control valve, the degree of opening of which is varied in accordance with the amount of a supplied current; a piston housed in a cylinder supplied with working oil, the pressure of which is adjusted by the control valve; and a friction clutch that is pressed by the piston. The friction clutch includes a plurality of clutch plates that are rotatable together with an input rotary member and a plurality of clutch plates that are rotatable together with an output rotary member, the clutch plates being disposed alternately in the axial direction. When the friction clutch is pressed, the plurality of clutch plates are brought into frictional contact with each other so that torque that matches a pressing force is transferred from the input rotary member to the output rotary member. Lubricating oil is present between the plurality of clutch plates of the friction clutch to lubricate the clutch plates which are in frictional contact with each other.

In the friction clutch configured as described above, the presence of the lubricating oil between the clutch plates suppresses wear of the clutch plates. However, drag torque is generated between the clutch plates by the viscosity of the lubricating oil even in the case where the friction clutch does not receive a pressing force. Such drag torque becomes distinguished particularly at a low temperature.

In the four-wheel-drive vehicle which includes the friction clutch configured as described above, in order to reduce the drag torque during two-wheel drive when a drive force is not transferred to the auxiliary drive wheels, it is desirable to increase the spacing between the plurality of clutch plates. However, increasing the spacing between the clutch plates increases the amount of movement of the piston. Therefore, it takes time since the pump is actuated until the spacing between the clutch plates is reduced during transition from a two-wheel-drive state to a four-wheel-drive state, which increases the delay time until the start of transfer of a drive force to the auxiliary drive wheels via the friction clutch. That is, the response of the friction clutch may be reduced.

### SUMMARY OF THE INVENTION

An object of the present invention is to provide a drive force transfer device that includes a friction clutch with improved response at the time when the friction clutch is pressed by the hydraulic pressure of working oil supplied from a pump.

An aspect of the present invention provides a drive force transfer device including: a first rotary member; a second rotary member that is rotatable relative to the first rotary member, a friction clutch that transfers a drive force of a drive source, and that has a plurality of first friction plates that are rotatable together with the first rotary member and a plurality of second friction plates that are rotatable together with the second rotary member; a pressing member that receives a hydraulic pressure of working oil supplied to a cylinder to press the friction clutch; a hydraulic circuit that supplies the cylinder with the working oil; and a control device that controls the hydraulic circuit, in which the hydraulic circuit has a first pump that supplies the cylinder with the working oil, and a second pump that supplies the cylinder with the working oil at a pressure that is higher than that of the working oil supplied by the first pump.

With the drive force transfer device according to the above aspect, it is possible to improve the response of a friction clutch at the time when the friction clutch is pressed by the hydraulic pressure of working oil supplied from a pump.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating an example of the configuration of a four-wheel-drive vehicle on which a drive force transfer device according to a first embodiment is mounted;

FIG. 2 is a sectional view illustrating an example of the configuration of the drive force transfer device according to the first embodiment;

FIG. 3 is a schematic diagram illustrating an example of the configuration of a hydraulic circuit according to the first embodiment;

FIG. 4 is a timing chart illustrating operation of the hydraulic circuit according to the first embodiment;

FIG. 5 is a schematic diagram illustrating an example of the configuration of a hydraulic circuit according to a second embodiment;

FIG. 6 is a timing chart illustrating operation of the hydraulic circuit according to the second embodiment;

FIG. 7 is a schematic diagram illustrating an example of the configuration of a hydraulic circuit according to a third embodiment; and

FIG. 8 is a timing chart illustrating operation of the hydraulic circuit according to the third embodiment.

### DETAILED DESCRIPTION OF EMBODIMENTS

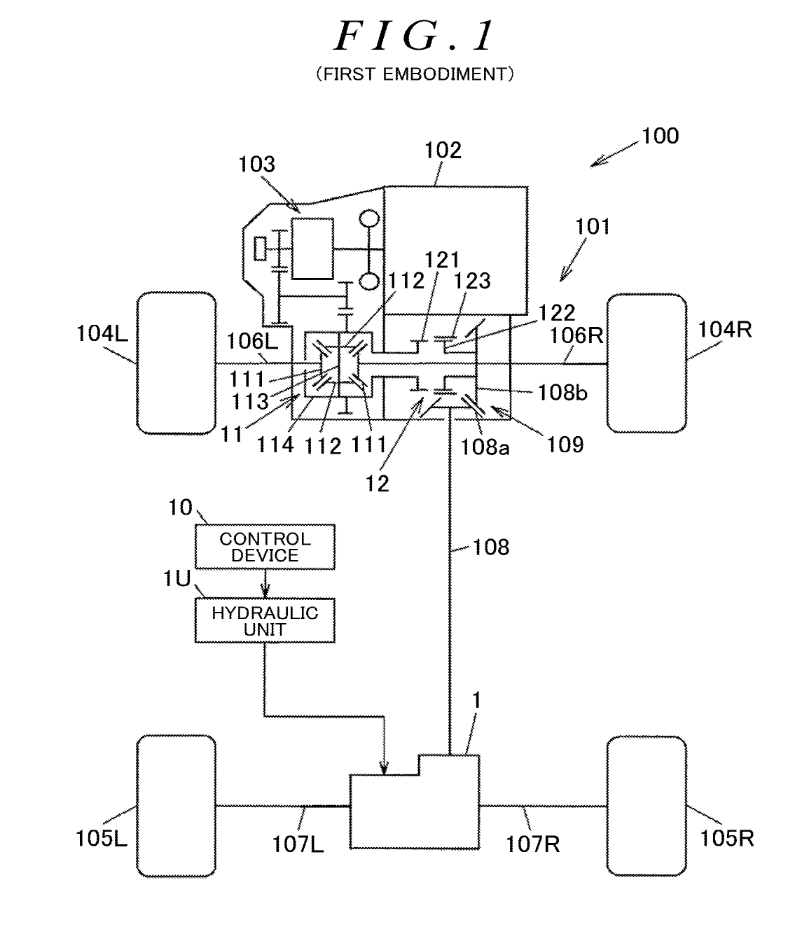

A first embodiment of the present invention will be described with reference to FIGS. 1 to 4.

FIG. 1 is a diagram illustrating an example of the configuration of a four-wheel-drive vehicle on which a drive force transfer device according to a first embodiment of the present invention is mounted.

A four-wheel-drive vehicle 100 includes an engine 102 that serves as a drive source that generates a drive force for travel, a transmission 103, a pair of right and left front wheels 104R, 104L that serve as main drive wheels, a pair of right and left rear wheels 105R, 105L that serve as auxiliary drive wheels, and a drive force transfer system 101 capable of transferring the drive force of the engine 102 to the front wheels 104R, 104L and the rear wheels 105R, 105L. In the embodiment, the symbols R and L mean the right side and the left side, respectively, with respect to the direction of forward travel of the vehicle.

The four-wheel-drive vehicle 100 is switchable between a four-wheel-drive state, in which the drive force of the engine 102 is transferred to the front wheels 104R, 104L and the rear wheels 105R, 105L, and a two-wheel-drive state, in which the drive force of the engine 102 is transferred to only the front wheels 104R, 104L. In the embodiment, the engine which is an internal combustion engine is applied as the drive source. However, the present invention is not limited thereto, and the drive source may be constituted of a combination of an engine and a high-power electric motor such as an interior permanent magnet (IPM) motor, or may be constituted of only a high-power electric motor.

The drive force transfer system 101 has a front differential 11, a mesh clutch 12 that serves as a connection/disconnection mechanism capable of interrupting transfer of a drive force, a propeller shaft 108, a drive force transfer device 1, drive shafts 106R, 106L on the front wheel side, and drive shafts 107R, 107L on the rear wheel side, and is configured to transfer the drive force of the engine 102 to the front wheels 104R, 104L and the rear wheels 105R, 105L. The drive force transfer device 1 includes a control device 10, and a hydraulic unit 1U controlled by the control device 10. The control device 10 is an aspect of the control device according to the present invention.

The drive force of the engine 102 is always transferred to the front wheels 104R, 104L. The drive force of the engine 102 is transferred to the rear wheels 105R, 105L via the mesh clutch 12, the propeller shaft 108, and the drive force transfer device 1.

The front differential 11 has: a pair of side gears 111, 111 coupled to the pair of drive shafts 106R, 106L on the front wheel side; a pair of pinion gears 112, 112 meshed with the pair of side gears 111, 111 with gear axes of the pinion gears orthogonal to gear axes of the side gears; a pinion shaft 113 that supports the pair of pinion gears 112, 112; and a front differential case 114 that houses the pair of side gears 111, 111, the pair of pinion gears 112, 112, and the pinion shaft 113.

The mesh clutch 12 has: a first clutch wheel 121 that is rotatable together with the front differential case 114; a second clutch wheel 122 arranged side by side with the first clutch wheel 121 in the axial direction; and a cylindrical sleeve 123 disposed on the outer side of the first clutch wheel 121 and the second clutch wheel 122 and capable of coupling the first clutch wheel 121 and the second clutch wheel 122 so as not to be relatively rotatable. The sleeve 123 is movable back and forth in the axial direction by an actuator (not illustrated). Actuation of the actuator allows switching between a coupled state, in which the first clutch wheel 121 and the second clutch wheel 122 are coupled by the sleeve 123 so as to rotate together with each other, and a decoupled state, in which the first clutch wheel 121 and the second clutch wheel 122 are relatively rotatable.

The propeller shaft 108 receives torque of the engine 102 from the front differential case 114 via the mesh clutch 12, and transfers the torque to the drive force transfer device 1 side. An end portion of the propeller shaft 108 on the front wheel side is provided with a pinion gear 108a that is meshed with a ring gear 108b coupled to the second clutch wheel 122 of the mesh clutch 12 so as not to be relatively rotatable. The ring gear 108b and the pinion gear 108a are hypoid gears, for example, and constitute a gear mechanism 109.

When the four-wheel-drive vehicle 100 is in the four-wheel-drive state, the mesh clutch 12 is in the coupled state, and the drive force of the engine 102 is transferred toward the pair of right and left rear wheels 105R, 105L via the propeller shaft 108 and the drive force transfer device 1. In the two-wheel-drive state, on the other hand, the mesh clutch 12 is in the decoupled state, and transfer of the drive force of the engine 102 to the propeller shaft 108 is interrupted.

In the four-wheel-drive state, the drive force transfer device 1 distributes the drive force input from the propeller shaft 108 to the pair of right and left rear wheels 105R, 105L while allowing differential motion. The drive shaft 107R is coupled to the right rear wheel 105R. The drive shaft 107L is coupled to the left rear wheel 105L.

The hydraulic unit 1U is controlled by the control device 10 on the basis of a signal from a drive state changeover switch that is operable by a driver, for example. The drive force transfer device 1 is actuated by the pressure of working oil, and transfers a drive force from the propeller shaft 108 to the drive shafts 107R, 107L on the rear wheel side.

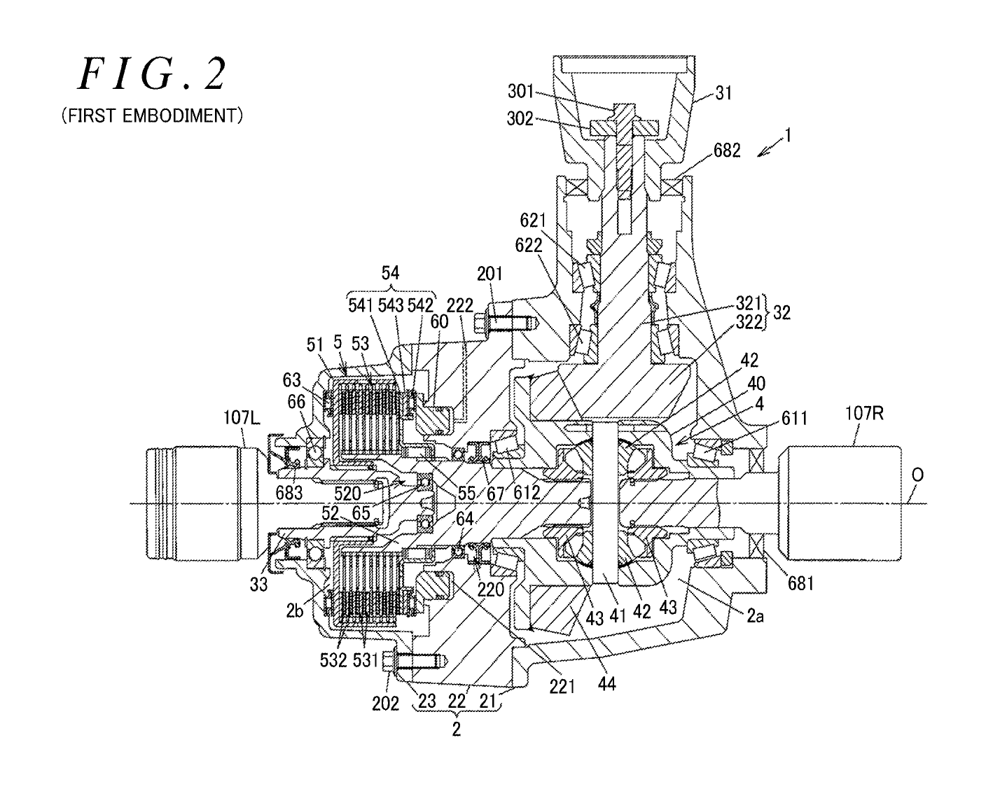

FIG. 2 is a sectional view, taken along a horizontal plane, illustrating an example of the configuration of a body portion (mechanism portion) of the drive force transfer device 1.

As illustrated in FIG. 2, the drive force transfer device 1 includes: a housing 2 constituted from first to third housing members 21 to 23; a coupling member 31 to which the propeller shaft 108 is coupled; a pinion gear shaft 32 that is rotatable together with the coupling member 31; a differential mechanism 4 that distributes the drive force of the engine 102 transferred via the propeller shaft 108 to the pair of right and left rear wheels 105R, 105L while allowing differential motion in the four-wheel-drive state; a clutch mechanism 5 capable of adjusting the drive force transferred from the differential mechanism 4 to the rear wheel 105L; and a piston 60 that serves as a pressing member that operates in accordance with the pressure of working oil supplied from the hydraulic unit 1U (illustrated in FIG. 1).

The clutch mechanism 5 has a friction clutch 53 that is pressed by the piston 60, and is disposed between the drive shaft 107L and the differential mechanism 4. The second housing member 22 is provided with an annular cylinder 221 to which working oil is supplied from the hydraulic unit 1U, and a working oil supply hole 222 that communicates with the cylinder 221. One end portion of the piston 60 is housed in the cylinder 221. The piston 60 receives the hydraulic pressure of working oil supplied to the cylinder 221 to press the friction clutch 53. In FIG. 2, the working oil supply hole 222 is indicated by the dashed line.

The differential mechanism 4 has: a differential case 40; a pinion shaft 41 supported by the differential case 40; a pair of pinion gears 42, 42 supported by the pinion shaft 41; a pair of side gears 43, 43 meshed with the pair of pinion gears 42, 42 with gear axes of the pinion gears orthogonal to gear axes of the side gears; and a ring gear 44 that is rotatable together with the differential case 40. Both end portions of the differential case 40 in the vehicle width direction are rotatably supported by tapered roller bearings 611, 612 so that the differential case 40 is rotatable together with the pinion shaft 41 about a rotational axis O.

A coupling shaft 33 is disposed coaxially with a first side gear 43, among the pair of side gears 43, 43 of the differential mechanism 4, via the clutch mechanism 5, and the drive shaft 107R is coupled to a second side gear 43 so as not to be relatively rotatable. The drive shaft 107L is coupled to the coupling shaft 33 so as not to be relatively rotatable. In FIG. 2, an outer race of a constant-velocity joint disposed at end portions of the drive shafts 107R, 107L on the rear wheel side is illustrated.

The coupling member 31 and the pinion gear shaft 32 are coupled to each other by a bolt 301 and a washer 302. The pinion gear shaft 32 has a shaft portion 321 and a gear portion 322. The shaft portion 321 is rotatably supported by a pair of tapered roller bearings 621, 622. The gear portion 322 is meshed with the ring gear 44 of the differential mechanism 4.

The clutch mechanism 5 is disposed between one of the side gears 43 and the coupling shaft 33, and transfers a drive force from the one of the side gears 43 toward the coupling shaft 33 using the friction clutch 53. When the four-wheel-drive vehicle 100 is in the four-wheel-drive state, and when the drive force which is transferred from the one of the side gears 43 to the drive shaft 107L through the coupling shaft 33 is adjusted by the clutch mechanism 5, a drive force that is equivalent to the drive force which is transferred to the drive shaft 107L is also transferred to the drive shaft 107R.

The housing 2 has: the first housing member 21 which houses the pinion gear shaft 32 and the differential mechanism 4; the second housing member 22 which is coupled to the first housing member 21 by a plurality of bolts 201; and the third housing member 23 which is coupled to the second housing member 22 by a plurality of bolts 202. In FIG. 2, one bolt 201 and one bolt 202, among the plurality of bolts 201 and 202, are illustrated.

In the housing 2, a first housing chamber 2a that houses the differential mechanism 4 and a second housing chamber 2b that houses the clutch mechanism 5 are separated by a seal member 67 fixed to the inner surface of a shaft hole 220 formed at the center portion of the second housing member 22. Lubricating oil (gear oil) with a viscosity that is suitable to lubricate gears is sealed in the first housing chamber 2a.

Lubricating oil (clutch oil) with a relatively low viscosity that lubricates a plurality of outer clutch plates 531 and a plurality of inner clutch plates 532 that constitute the friction clutch 53 of the clutch mechanism 5 and that are in frictional sliding is sealed in the second housing chamber 2b. Occurrence of wear or seizure of the plurality of outer clutch plates 531 and the plurality of inner clutch plates 532 is suppressed by the lubricating oil.

A seal member 681 is fitted with the inner surface of an insertion hole of the first housing member 21 through which the drive shaft 107R is inserted. A seal member 682 is fitted with the inner surface of an insertion hole of the first housing member 21 through which the coupling member 31 and the pinion gear shaft 32 are inserted. A seal member 683 is fitted with the inner surface of an insertion hole of the third housing member 23 through which the coupling shaft 33 is inserted.

The clutch mechanism 5 has: a clutch drum 51 that serves as a first rotary member that is rotatable together with the coupling shaft 33; an inner shaft 52 that serves as a second rotary member that is rotatable together with one of the side gears 43 of the differential mechanism 4; the friction clutch 53 which transfers a drive force between the clutch drum 51 and the inner shaft 52; and a pressing force transfer mechanism 54 that transfers the pressing force of the piston 60 to the friction clutch 53. The clutch drum 51 and the inner shaft 52 are rotatable relative to each other on the same axis.

The friction clutch 53 has the plurality of outer clutch plates 531 which serve as first friction plates that are rotatable together with the clutch drum 51, and the plurality of inner clutch plates 532 which serve as second friction plates that are rotatable together with the inner shaft 52. In the embodiment, the friction clutch 53 has nine outer clutch plates 531 and nine inner clutch plates 532, and the outer clutch plates 531 and the inner clutch plates 532 are disposed alternately along the axial direction.

The outer clutch plates 531 have a plurality of projections provided at their end portions on the outer peripheral side to be spline-engaged with the inner peripheral surface of the clutch drum 51, and are coupled so as to be movable in the axial direction with respect to and not to be rotatable relative to the clutch drum 51. Meanwhile, the inner clutch plates 532 have a plurality of projections formed at their end portions on the inner peripheral side to be spline-engaged with the outer peripheral surface of the inner shaft 52, and are coupled so as to be movable in the axial direction with respect to and not to be rotatable relative to the inner shaft 52.

When the friction clutch 53 receives the pressing force of the piston 60 via the pressing force transfer mechanism 54, a friction force is generated between the plurality of outer clutch plates 531 and the plurality of inner clutch plates 532, which allows the friction clutch 53 to transfer a drive force. The pressing force transfer mechanism 54 has: an annular slide member 541 coupled in the axial direction so as not to be rotatable relative to the inner shaft 52; a thrust needle roller bearing 542; and a shim 543 that adjusts the position of the pressing force transfer mechanism 54 in the direction of the rotational axis O.

The slide member 541 is urged by an urging member 55 in the direction away from the friction clutch 53. The urging member 55 is constituted from an elastic body such as a spring, for example. One end portion of the urging member 55 in the axial direction abuts against a stepped surface formed on the inner shaft 52. The other end portion of the urging member 55 in the axial direction abuts against an inner flange portion of the slide member 541.

A thrust roller bearing 63 is disposed between the clutch drum 51 and the inner surface of the third housing member 23. The thrust roller bearing 63 restricts movement of the clutch drum 51 in the axial direction. The inner shaft 52 is rotatably supported by a ball bearing 64 fixed to the inner surface of the shaft hole 220. A housing hole 520 that houses one end portion of the coupling shaft 33 is formed at the center portion of the inner shaft 52. The coupling shaft 33 is rotatably supported by a ball bearing 65 disposed between the inner surface of the housing hole 520 and the coupling shaft 33 and a ball bearing 66 disposed between the third housing member 23 and the coupling shaft 33.

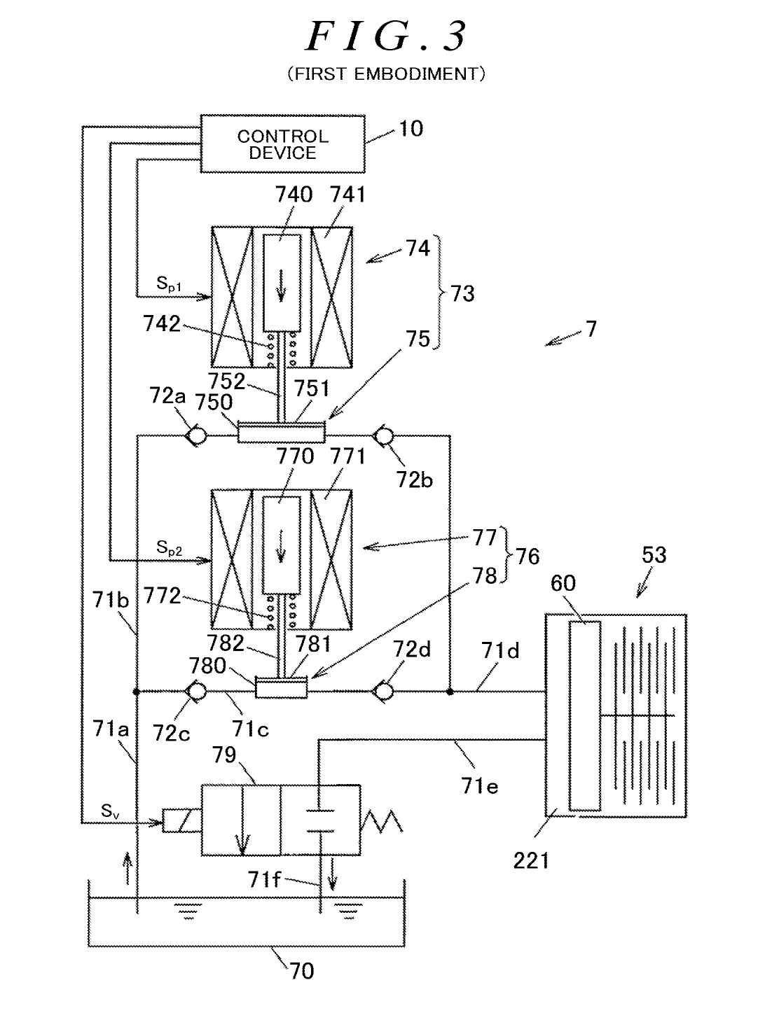

FIG. 3 is a schematic diagram illustrating an example of the configuration of a hydraulic circuit 7 of the hydraulic unit 1U. The hydraulic circuit 7 has: a reservoir 70; a first electromagnetic pump 73 that supplies the cylinder 221 with working oil stored in the reservoir 70 via conduits 71a, 71b, check valves 72a, 72b, and a conduit 71d; a second electromagnetic pump 76 that supplies the cylinder 221 with the working oil stored in the reservoir 70 via the conduit 71a, a conduit 71c, check valves 72c, 72d, and the conduit 71d; and a control valve 79 provided in a conduit 71e that returns from the cylinder 221 to the reservoir 70. The control valve 79 functions as a valve that relieves the pressure in the cylinder 221.

The circuit elements of the hydraulic circuit 7, namely the first electromagnetic pump 73, the second electromagnetic pump 76, and the control valve 79, are controlled by the control device 10. Hereinafter, supply of a current from the control device 10 to the circuit elements of the hydraulic circuit will be referred to as “ON”, and interruption of such a current will be referred to as “OFF”.

The first electromagnetic pump 73 includes a first solenoid portion 74 that generates an electromagnetic force, and a first pump portion 75 that is actuated by the electromagnetic force of the first solenoid portion 74. The second electromagnetic pump 76 includes a second solenoid portion 77 that generates an electromagnetic force, and a second pump portion 78 that is actuated by the electromagnetic force of the second solenoid portion 77. The first pump portion 75 is an aspect of the first pump according to the present invention. The second pump portion 78 is an aspect of the second pump according to the present invention. The first solenoid portion 74 is an aspect of the first secondary drive source according to the present invention. The second solenoid portion 77 is an aspect of the second secondary drive source according to the present invention.

The first solenoid portion 74 includes: a plunger 740 provided so as to be movable in the axial direction; a solenoid 741 that generates an electromagnetic force along with “ON” to move the plunger 740 in the direction of the arrow in FIG. 3; and a spring 742 that urges the plunger 740 away from the first pump portion 75. As with the first solenoid portion 74, the second solenoid portion 77 includes: a plunger 770 provided so as to be movable in the axial direction; a solenoid 771 that generates an electromagnetic force along with “ON” to move the plunger 770 in the direction of the arrow in FIG. 3; and a spring 772 that urges the plunger 770 away from the second pump portion 78.

The first pump portion 75 includes: a cylinder portion 750 that communicates with the conduit 71b; a piston portion 751 that is movable within the cylinder portion 750 to supply the cylinder 221 with working oil via the conduit 71b, the check valve 72b, and the conduit 71d; and a shaft 752 that couples the piston portion 751 to the plunger 740. The second pump portion 78 includes: a cylinder portion 780 that communicates with the conduit 71c; a piston portion 781 that is movable within the cylinder portion 780 to supply the cylinder 221 with working oil via the conduit 71c, the check valve 72d, and the conduit 71d; and a shaft 782 that couples the piston portion 781 to the plunger 770.

The first pump portion 75 is configured to supply the cylinder 221 with working oil at a high flow rate and at a low pressure compared to working oil supplied by the second pump portion 78. Specifically, the piston portion 751 of the first pump portion 75 is formed to have a pressure receiving area that is at least twice or more the pressure receiving area of the piston portion 781 of the second pump portion 78. In addition, the amount of working oil discharged by the first pump portion 75 per one reciprocal motion of the plunger 740 is larger than the amount of working oil discharged from the second pump portion 78 per one reciprocal motion of the plunger 770. Therefore, the first pump portion 75 can discharge working oil at a flow rate that is higher than that of working oil discharged by the second pump portion 78.

When the friction clutch 53 is in an inactivated state in which a current is not supplied from the control device 10 to the first electromagnetic pump 73, the second electromagnetic pump 76, and the control valve 79, a predetermined clearance is present between the outer clutch plates 531 and the inner clutch plates 532, and lubricating oil is present in the clearance.

When the friction clutch 53 is actuated, working oil is supplied from the hydraulic unit 1U to the cylinder 221. When working oil is supplied to the cylinder 221, the piston 60 operates (hereinafter referred to as “feed operation”) until the clearance becomes zero with the outer clutch plates 531 and the inner clutch plates 532 contacting each other. When working oil is continuously supplied to the cylinder 221, the piston 60 operates (hereinafter referred to as “pressurizing operation”) from the state in which the clearance is zero until a predetermined friction force is generated between the outer clutch plates 531 and the inner clutch plates 532.

The control valve 79 connects the conduit 71e and a conduit 71f to each other along with “ON”. Consequently, the control valve 79 relieves the pressure in the cylinder 221.

The control device 10 controls the hydraulic circuit 7 in a manner to mainly supply the cylinder 221 with working oil at a high flow rate and at a low pressure during the feed operation, and in a manner to supply the cylinder 221 with working oil at a low flow rate and at a high pressure in order to generate a pressing force necessary for the piston 60 during the pressurizing operation.

Specifically, when a signal for switching the four-wheel-drive vehicle 100 from the two-wheel-drive state to the four-wheel-drive state is received, the control device 10 outputs a first pump signal Sₚ₁ that repeatedly turns ON and OFF a plurality of times to the first electromagnetic pump 73, and outputs a second pump signal Sₚ₂ that repeatedly turns ON and OFF a plurality of times in phase with and in sync with the first pump signal Sₚ₁ to the second electromagnetic pump 76, in order to perform the feed operation. During the pressurizing operation, meanwhile, the control device 10 outputs the second pump signal Sₚ₂ only to the second electromagnetic pump 76. When the control device 10 operates (hereinafter referred to as “release operation”) to return the working oil in the cylinder 221 to the reservoir 70, the control device 10 outputs a valve signal Sᵥ for ON to the control valve 79.

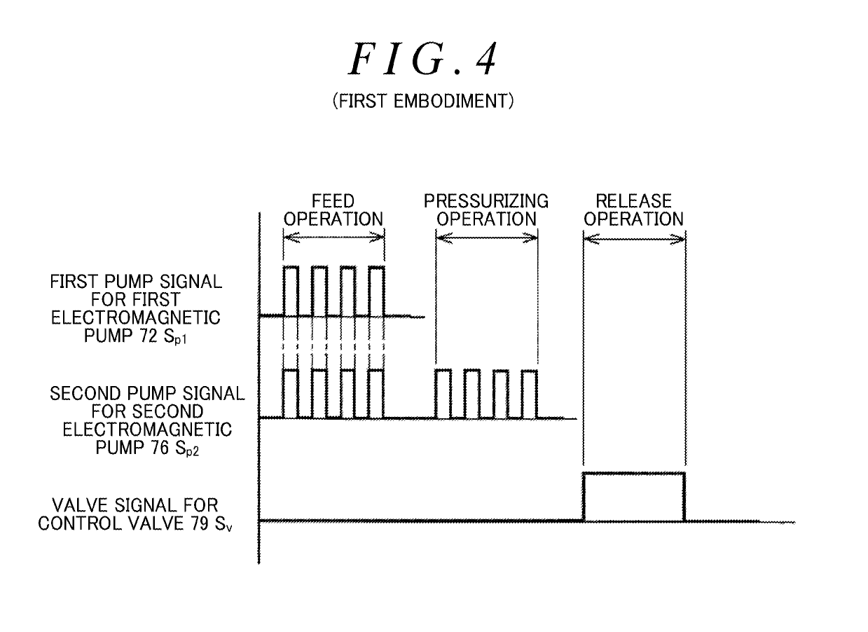

FIG. 4 is a timing chart illustrating operation of the hydraulic circuit 7 achieved by the control device 10. Operation of the hydraulic circuit 7, namely (1) feed operation, (2) pressurizing operation, and (3) release operation, will be separately described below. The number of pulses of the signals and the intervals between the operations illustrated in FIG. 4 are exemplary, and the present invention is not limited thereto.

(1) Feed Operation

When a signal for switching from the two-wheel-drive state to the four-wheel-drive state is received, the control device 10 outputs a first pump signal Sₚ₁ that repeatedly turns ON and OFF a plurality of times to the first solenoid portion 74 of the first electromagnetic pump 73, and outputs a second pump signal Sₚ₂ that repeatedly turns ON and OFF a plurality of times in phase with and in sync with the first pump signal Sₚ₁ to the second solenoid portion 77 of the second electromagnetic pump 76, as illustrated in FIG. 4.

When the first pump signal Sₚ₁ from the control device 10 is turned OFF, the first solenoid portion 74 of the first electromagnetic pump 73 allows the plunger 740 to be slid away from the first pump portion 75 using the spring force of the spring 742. When the second pump signal Sₚ₂ from the control device 10 is turned OFF, the second solenoid portion 77 of the second electromagnetic pump 76 allows the plunger 770 to be slid away from the second pump portion 78 using the spring force of the spring 772. In this event, working oil from the reservoir 70 is suctioned into the first pump portion 75 and the second pump portion 78.

When the first pump signal Sₚ₁ from the control device 10 is turned ON, the first solenoid portion 74 of the first electromagnetic pump 73 slides the plunger 740 toward the first pump portion 75 by generating an electromagnetic force. Working oil suctioned into the first pump portion 75 is supplied to the cylinder 221 via the conduit 71b, the check valve 72b, and the conduit 71d. When the second pump signal Sₚ₂ from the control device 10 is turned ON, the second solenoid portion 77 of the second electromagnetic pump 76 slides the plunger 770 toward the second pump portion 78 by generating an electromagnetic force. Working oil suctioned into the second pump portion 78 is supplied to the cylinder 221 via the conduit 71c, the check valve 72d, and the conduit 71d. That is, the cylinder 221 is supplied with working oil at a low pressure but at a high flow rate from the first pump portion 75 and supplied with working oil at a high pressure but at a low flow rate from the second pump portion 78 at the same timing.

As described above, during the feed operation, the control device 10 outputs the first pump signal Sₚ₁, which repeatedly turns ON and OFF, to the first electromagnetic pump 73, and outputs the second pump signal Sₚ₂, which repeatedly turns ON and OFF, to the second electromagnetic pump 76. The first pump portion 75 and the second pump portion 78 repeatedly suction and discharge working oil to intermittently supply the cylinder 221 with the working oil as a plurality of portions.

(2) Pressurizing Operation

When the pressurizing operation is finished, the control device 10 outputs the second pump signal Sₚ₂, which is turned ON and OFF a plurality of times, only to the second electromagnetic pump 76. When the second pump signal Sₚ₂ is turned OFF, the second solenoid portion 77 of the second electromagnetic pump 76 allows the plunger 770 to be slid away from the second pump portion 78 using the spring force of the spring 772.

When the second pump signal Sₚ₂ is turned ON, the second solenoid portion 77 of the second electromagnetic pump 76 allows the plunger 770 to be slid toward the second pump portion 78. The working oil which has been suctioned into the second pump portion 78 is supplied to the cylinder 221. That is, working oil at a high pressure but at a low flow rate from the second pump portion 78 is intermittently supplied to the cylinder 221.

As described above, during the pressurizing operation, the control device 10 outputs the second pump signal Sₚ₂, which repeatedly turns ON and OFF, to the second electromagnetic pump 76. The second pump portion 78 repeatedly suctions and discharges working oil to intermittently supply the cylinder 221 with the working oil as a plurality of portions.

(3) Release Operation

When working oil is returned from the cylinder 221 to the hydraulic unit 1U side to reduce the pressing force for the friction clutch 53, the control device 10 outputs a valve signal Sᵥ to the control valve 79. The working oil in the cylinder 221 is returned to the reservoir 70 via the conduit 71e, the control valve 79, and the conduit 71f.

The function and the effect of the first embodiment will be described. With the first embodiment described above, during the feed operation, the cylinder 221 is supplied with working oil at a low pressure but at a high flow rate from the first pump portion 75 and supplied with working oil at a low flow rate but at a high pressure from the second pump portion 78 at the same timing. Thus, the feed operation can be performed rapidly to enhance the response of the friction clutch 53. During the pressurizing operation, meanwhile, the cylinder 221 is supplied with working oil at a low flow rate but at a high pressure from the second pump portion 78 without the first pump portion 75 in operation. Thus, the piston 60 can be provided with a necessary pressing force with a low power consumption.

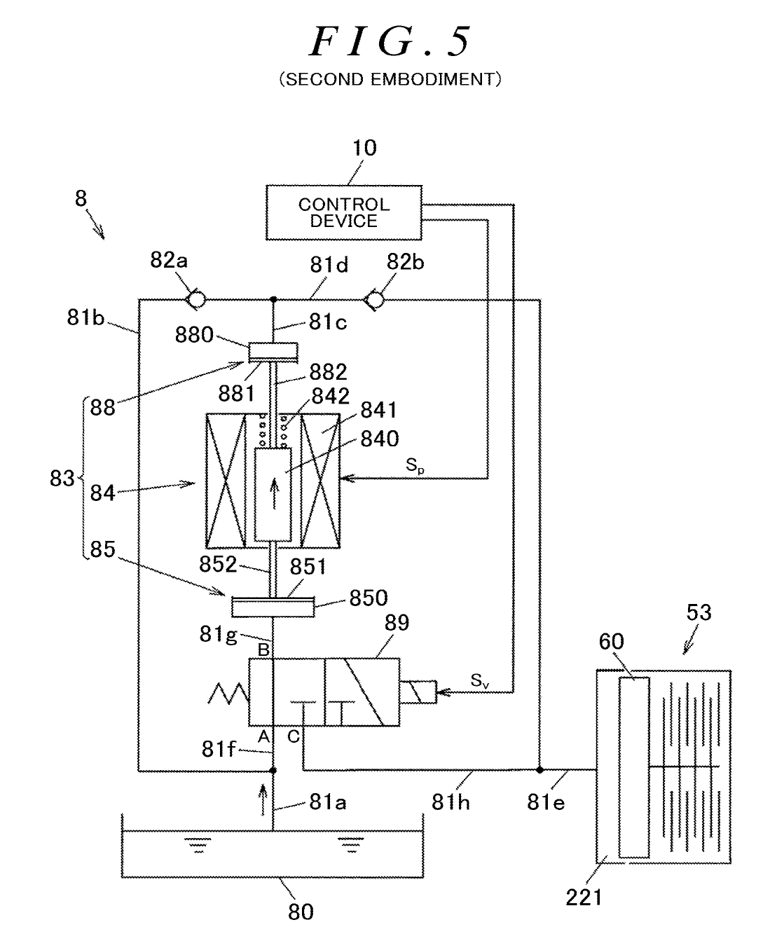

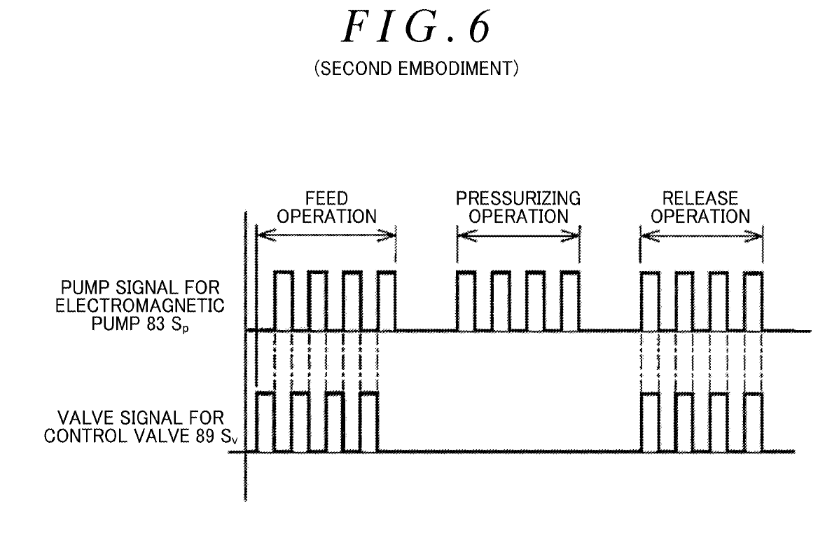

Next, a second embodiment of the present invention will be described with reference to FIGS. 5 and 6.

FIG. 5 is a schematic diagram illustrating an example of the configuration of a hydraulic circuit 8 according to the second embodiment. In the first embodiment, the first pump portion 75 and the second pump portion 78 each have one solenoid portion 74, 77 and one pump portion 75, 78. In the present embodiment, however, one electromagnetic pump 83 that has one solenoid portion 84 and two pump portions 85, 88 is used.

The hydraulic circuit 8 includes: a reservoir 80; the electromagnetic pump 83 which supplies the cylinder 221 with working oil stored in the reservoir 80 via conduits 81a to 81h and check valves 82a, 82b; and a control valve 89. The control valve 89 functions as a valve that relieves the pressure in the cylinder 221.

The electromagnetic pump 83 includes: the solenoid portion 84 which generates an electromagnetic force; a first pump portion 85 that is actuated by the spring force of a spring 842; and a second pump portion 88 that is actuated by the electromagnetic force of the solenoid portion 84. The first pump portion 85 is an aspect of the first pump according to the present invention. The second pump portion 88 is an aspect of the second pump according to the present invention. The solenoid portion 84 is an aspect of the single secondary drive source according to the present invention.

The solenoid portion 84 includes: a plunger 840 provided so as to be movable in the axial direction; a solenoid 841 that generates an electromagnetic force along with “ON” to move the plunger 840 in the direction of the arrow in FIG. 5; and the spring 842 which urges the plunger 840 toward the first pump portion 85.

The first pump portion 85 includes: a cylinder portion 850 that communicates with the conduit 81g; a piston portion 851 that is movable within the cylinder portion 850 to supply the cylinder 221 with working oil via the conduit 81g, the control valve 89, and the conduits 81h, 81e; and a shaft 852 that couples the piston portion 851 to the plunger 840.

The second pump portion 88 includes: a cylinder portion 880 that communicates with the conduit 81c; a piston portion 881 that is movable within the cylinder portion 880 to supply the cylinder 221 with working oil via the conduits 81c, 81d, the check valve 82b, and the conduit 81e; and a shaft 882 that couples the piston portion 881 to the plunger 840.

The first pump portion 85 supplies the cylinder 221 with working oil at a high flow rate and at a low pressure compared to working oil supplied by the second pump portion 88. Specifically, the piston portion 851 of the first pump portion 85 is formed to have a pressure receiving area that is at least twice or more the pressure receiving area of the piston portion 881 of the second pump portion 88. In addition, the amount of working oil discharged by the first pump portion 85 per one reciprocal motion of the plunger 840 is larger than the amount of working oil discharged from the second pump portion 88 per one reciprocal motion of the plunger 840. Therefore, the first pump portion 85 can discharge working oil at a flow rate that is higher than that of working oil discharged by the second pump portion 88.

The control valve 89 is a three-way valve that has a port A connected to the conduit 81f, a port B connected to the conduit 81g, and a port C connected to the conduit 81h. The control valve 89 is configured such that the port A and the port B are connected to each other when the control valve 89 is turned OFF, and such that the port B and the port C are connected to each other when the control valve 89 is turned ON.

When a signal for switching the four-wheel-drive vehicle 100 from the two-wheel-drive state to the four-wheel-drive state is received, the control device 10 outputs a pump signal Sₚ that repeatedly turns ON and OFF a plurality of times to the electromagnetic pump 83, and outputs a valve signal Sᵥ that repeatedly turns ON and OFF a plurality of times in opposite phase to and in sync with the pump signal Sₚ to the control valve 89, in order to perform the feed operation. During the pressurizing operation, meanwhile, the control device 10 outputs the pump signal Sₚ only to the electromagnetic pump 83. During the release operation, further, the control device 10 outputs a pump signal Sₚ that repeatedly turns ON and OFF a plurality of times to the electromagnetic pump 83, and outputs a valve signal Sᵥ that repeatedly turns ON and OFF a plurality of times in phase with and in sync with the pump signal Sₚ to the control valve 89.

FIG. 6 is a timing chart illustrating operation of the hydraulic circuit 8 according to the second embodiment. Operation of the hydraulic circuit 8 according to the embodiment, namely (1) feed operation, (2) pressurizing operation, and (3) release operation, will be separately described below. The number of pulses of the signals and the intervals between the operations illustrated in FIG. 6 are exemplary, and the present invention is not limited thereto.

(1) Feed Operation

When a signal for switching from the two-wheel-drive state to the four-wheel-drive state is received, the control device 10 outputs a pump signal Sₚ that repeatedly turns ON and OFF a plurality of times to the solenoid portion 84 of the electromagnetic pump 83, and outputs a valve signal Sᵥ that repeatedly turns ON and OFF a plurality of times in opposite phase to and in sync with the pump signal Sₚ to the control valve 89, as illustrated in FIG. 6.

When the pump signal Sₚ from the control device 10 is turned OFF, the solenoid portion 84 of the electromagnetic pump 83 allows the plunger 840 to be slid toward the first pump portion 85 using the spring force of the spring 842. In this event, the control valve 89 has been turned ON, and thus the port B and the port C are connected to each other. Consequently, the working oil in the first pump portion 85 is supplied to the cylinder 221 via the conduit 81g, the port B and the port C of the control valve 89, and the conduits 81h, 81e. That is, working oil at a low pressure but at a high flow rate from the first pump portion 85 is supplied to the cylinder 221. Meanwhile, the working oil in the reservoir 80 is suctioned into the second pump portion 88 via the conduits 81a, 81b, the check valve 82a, and the conduit 81c.

When the pump signal Sₚ is turned ON, meanwhile, the solenoid portion 84 of the electromagnetic pump 83 slides the plunger 840 toward the second pump portion 88 by generating an electromagnetic force. The working oil in the second pump portion 88 is supplied to the cylinder 221 via the conduits 81c, 81d, the check valve 82b, and the conduit 81e. That is, working oil at a high pressure but at a low flow rate from the second pump portion 88 is supplied to the cylinder 221. In this event, the control valve 89 has been turned OFF, and thus the port A and the port B are connected to each other. The working oil in the reservoir 80 is suctioned into the first pump portion 85 via the conduits 81a, 81f, the port A and the port B of the control valve 89, and the conduit 81g.

As described above, during the feed operation, the control device 10 outputs the pump signal Sₚ, which repeatedly turns ON and OFF, to the electromagnetic pump 83. The first pump portion 85 and the second pump portion 88 repeatedly suction and discharge working oil to continuously supply the cylinder 221 with the working oil.

(2) Pressurizing Operation

When the feed operation is finished, the control device 10 outputs a pulse signal, which repeatedly turns ON and OFF a plurality of times, to the electromagnetic pump 83, but does not output the valve signal Sᵥ to the control valve 89. That is, the control valve 89 is continuously turned OFF.

When the pump signal Sₚ is turned ON, the solenoid portion 84 of the electromagnetic pump 83 slides the plunger 840 toward the second pump portion 88 by generating an electromagnetic force. The working oil in the second pump portion 88 is supplied to the cylinder 221 via the conduits 81c, 81d, the check valve 82b, and the conduit 81e. That is, working oil at a low pressure but at a high flow rate from the second pump portion 88 is supplied to the cylinder 221. In this event, the control valve 89 has been turned OFF, and thus the port A and the port B are connected to each other. In addition, the working oil in the reservoir 80 is suctioned into the first pump portion 85 via the conduits 81a, 81f, the port A and the port B of the control valve 89, and the conduit 81g.

When the pump signal Sₚ from the control device 10 is turned OFF, the solenoid portion 84 of the electromagnetic pump 83 allows the plunger 840 to be slid toward the first pump portion 85 using the spring force of the spring 842. In this event, the control valve 89 has been turned OFF, and thus the port A and the port B are connected to each other. The working oil in the first pump portion 85 is not supplied to the cylinder 221, but returned to the reservoir 80 via the conduit 81g, the port B and the port A of the control valve 89, and the conduits 81f, 81a, or suctioned into the second pump portion 88 via the conduit 81b.

(3) Release Operation

When working oil is returned from the cylinder 221 to the hydraulic unit 1U side to reduce the pressing force for the friction clutch 53, the control device 10 outputs a pump signal Sₚ that repeatedly turns ON and OFF a plurality of times to the electromagnetic pump 83, and outputs a valve signal Sᵥ that repeatedly turns ON and OFF a plurality of times in phase with and in sync with the pump signal Sₚ to the control valve 89.

When the pump signal Sₚ is turned ON, the solenoid portion 84 of the electromagnetic pump 83 slides the plunger 840 toward the second pump portion 88. In this event, the control valve 89 has been turned ON, and thus the port B and the port C are connected to each other. The working oil in the second pump portion 88 is suctioned into the first pump portion 85 via the conduits 81c, 81d, the check valve 82b, the conduit 81h, and the control valve 89, and the working oil in the cylinder 221 is suctioned into the first pump portion 85 via the conduits 81e, 81h, the port C and the port B of the control valve 89, and the conduit 81g.

When the pump signal Sₚ is turned OFF, the solenoid portion 84 of the electromagnetic pump 83 allows the plunger 840 to be slid toward the first pump portion 85 using the spring force of the spring 842. In this event, the control valve 89 has been turned OFF, and thus the port A and the port B are connected to each other. The working oil in the first pump portion 85 is returned to the reservoir 80 via the conduit 81g, the control valve 89, and the conduit 81f.

The function and the effect of the second embodiment will be described. With the second embodiment described above, during the feed operation, the cylinder 221 is alternately supplied with working oil at a low pressure but at a high flow rate from the first pump portion 85 and supplied with working oil at a low flow rate but at a high pressure from the second pump portion 88. Thus, the feed operation can be performed rapidly to enhance the response of the friction clutch 53.

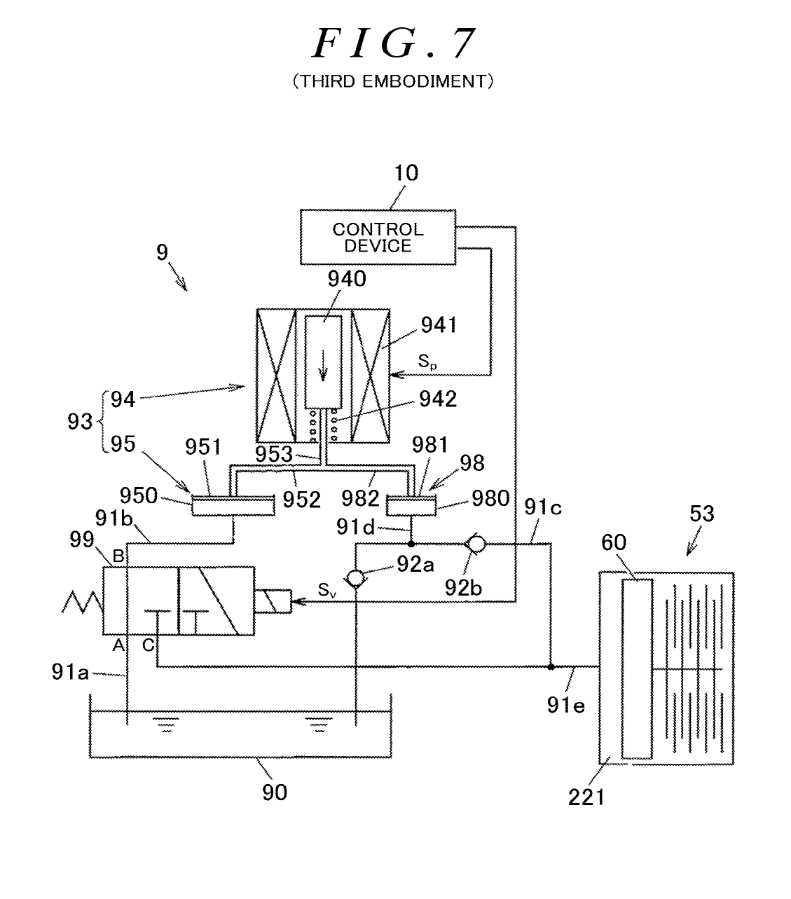

FIG. 7 is a schematic diagram illustrating an example of the configuration of a hydraulic circuit 9 according to a third embodiment. In the second embodiment, the pump portions 85, 88 are disposed on the respective sides of the solenoid portion 84 in the axial direction in the electromagnetic pump 83. In the present embodiment, however, two pump portions 95, 98 are disposed on one side of a solenoid portion 94 in the axial direction in an electromagnetic pump 93.

The hydraulic circuit 9 includes: a reservoir 90; the electromagnetic pump 93 which supplies the cylinder 221 with working oil stored in the reservoir 90 via conduits 91a to 91e and check valves 92a, 92b; and a control valve 99. The control valve 99 functions as a valve that relieves the pressure in the cylinder 221.

The electromagnetic pump 93 includes a solenoid portion 94 that generates an electromagnetic force, and a first pump portion 95 and a second pump portion 98 that are actuated by the electromagnetic force of the solenoid portion 94. The first pump portion 95 is an aspect of the first pump according to the present invention. The second pump portion 98 is an aspect of the second pump according to the present invention. The solenoid portion 94 is an aspect of the single secondary drive source according to the present invention.

The solenoid portion 94 includes: a plunger 940 provided so as to be movable in the axial direction; a solenoid 941 that generates an electromagnetic force along with “ON” to move the plunger 940 in the direction of the arrow in FIG. 7; and a spring 942 that urges the plunger 940 away from the first pump portion 95 and the second pump portion 98.

The first pump portion 95 includes: a cylinder portion 950 that communicates with the conduit 91b; a piston portion 951 that is movable within the cylinder portion 950 to supply the cylinder 221 with working oil via the conduit 91b, the control valve 99, and the conduit 91e; and a shaft 952 that couples the piston portion 951 to the plunger 940.

The second pump portion 98 includes: a cylinder portion 980 that communicates with the conduit 91d; a piston portion 981 that is movable within the cylinder portion 980 to supply the cylinder 221 with working oil via the conduits 91d, 91c, the check valve 92b, and the conduit 91e; and a shaft 982 that couples the piston portion 981 to the plunger 940.

The shaft 952 of the first pump portion 95 and the shaft 982 of the second pump portion 98 are coupled to the plunger 940 by a common shaft 953. The first pump portion 95 supplies the cylinder 221 with working oil at a high flow rate and at a low pressure compared to working oil supplied by the second pump portion 98. Specifically, the piston portion 951 of the first pump portion 95 is formed to have a pressure receiving area that is at least twice or more the pressure receiving area of the piston portion 981 of the second pump portion 98. In addition, the amount of working oil discharged by the first pump portion 95 per one reciprocal motion of the plunger 940 is larger than the amount of working oil discharged from the second pump portion 98 per one reciprocal motion of the plunger 940. Therefore, the first pump portion 95 can discharge working oil at a flow rate that is higher than that of working oil discharged by the second pump portion 98.

The control valve 99 is a three-way valve that has a port A connected to the conduit 91a, a port B connected to the conduit 91b, and a port C connected to the conduit 91e. The control valve 99 is configured such that the port A and the port B are connected to each other when the control valve 99 is turned OFF, and such that the port B and the port C are connected to each other when the control valve 99 is turned ON.

When a signal for switching the four-wheel-drive vehicle 100 from the two-wheel-drive state to the four-wheel-drive state is received, the control device 10 outputs a pump signal Sₚ that repeatedly turns ON and OFF a plurality of times to the electromagnetic pump 93, and outputs a valve signal Sᵥ that repeatedly turns ON and OFF a plurality of times in phase with and in sync with the pump signal Sₚ to the control valve 99, in order to perform the feed operation. During the pressurizing operation, meanwhile, the control device 10 outputs the pump signal Sₚ only to the electromagnetic pump 93. During the release operation, further, the control device 10 outputs a pump signal Sₚ that repeatedly turns ON and OFF a plurality of times to the electromagnetic pump 93, and outputs a valve signal Sᵥ that repeatedly turns ON and OFF a plurality of times in opposite phase to and in sync with the pump signal Sₚ to the control valve 99.

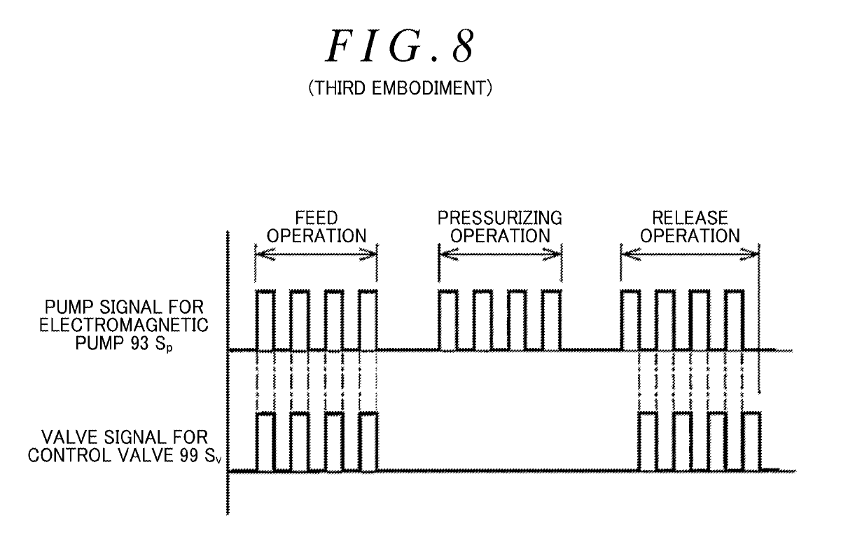

FIG. 8 is a timing chart illustrating operation of the hydraulic circuit 9 according to the third embodiment. Operation of the hydraulic circuit 9 according to the embodiment, namely (1) feed operation, (2) pressurizing operation, and (3) release operation, will be separately described below. The number of pulses of the signals and the intervals between the operations illustrated in FIG. 8 are exemplary, and the present invention is not limited thereto.

(1) Feed Operation

When a signal for switching from the two-wheel-drive state to the four-wheel-drive state is received, the control device 10 outputs a pump signal Sₚ that repeatedly turns ON and OFF a plurality of times to the solenoid portion 94 of the electromagnetic pump 93, and outputs a valve signal Sᵥ that repeatedly turns ON and OFF a plurality of times in phase with and in sync with the pump signal Sₚ to the control valve 99, as illustrated in FIG. 8.

When the pump signal Sₚ is turned OFF, the solenoid portion 94 of the electromagnetic pump 93 allows the plunger 940 to be slid away from the first pump portion 95 and the second pump portion 98 using the spring force of the spring 942. In this event, the control valve 99 has been turned OFF, and thus the port A and the port B are connected to each other. The working oil in the reservoir 90 is suctioned into the first pump portion 95 via the conduit 91a, the port A and the port B of the control valve 99, and the conduit 91b. Meanwhile, the working oil in the reservoir 90 is suctioned into the second pump portion 98 via the conduit 91c, the check valve 92a, and the conduit 91d.

When the pump signal Sₚ is turned ON, the solenoid portion 94 of the electromagnetic pump 93 slides the plunger 940 toward the first pump portion 95 and the second pump portion 98 by generating an electromagnetic force. In this event, the control valve 99 has been turned ON, and thus the port B and the port C are connected to each other. The working oil in the first pump portion 95 is supplied to the cylinder 221 via the conduit 91b, the port B and the port C of the control valve 99, and the conduit 91e. The working oil in the second pump portion 98 is supplied to the cylinder 221 via the conduits 91d, 91c, the check valve 92b, and the conduit 91e. That is, the cylinder 221 is intermittently supplied with working oil at a low pressure but at a high flow rate from the first pump portion 95 and supplied with working oil at a high pressure but at a low flow rate from the second pump portion 98.

(2) Pressurizing Operation

When the feed operation is finished, the control device 10 outputs a pump signal Sₚ, which repeatedly turns ON and OFF a plurality of times, to the electromagnetic pump 93, but does not output the valve signal Sᵥ to the control valve 99. That is, the control valve 99 is continuously turned OFF.

When the pump signal Sₚ is turned ON, the solenoid portion 94 of the electromagnetic pump 93 slides the plunger 940 toward the first pump portion 95 and the second pump portion 98. In this event, the control valve 99 has been turned OFF, and thus the port A and the port B are connected to each other so that the working oil in the first pump portion 95 is circulated to the reservoir 90 via the conduit 91b, the port B and the port A of the control valve 99, and the conduit 91a. The working oil in the second pump portion 98 is supplied to the cylinder 221 via the conduits 91d, 91c, 91e and the check valve 92b. That is, only working oil at a high pressure but at a low flow rate from the second pump portion 98 is supplied to the cylinder 221.

(3) Release Operation

When working oil is returned from the cylinder 221 to the hydraulic unit 1U side to reduce the pressing force for the friction clutch 53, the control device 10 outputs a pump signal Sₚ that repeatedly turns ON and OFF a plurality of times to the electromagnetic pump 93, and outputs a valve signal Sᵥ that repeatedly turns ON and OFF a plurality of times in opposite phase to and in sync with the pump signal Sₚ to the control valve 99.

When the pump signal Sₚ is turned ON, the solenoid portion 94 of the electromagnetic pump 93 slides the plunger 940 toward the first pump portion 95 and the second pump portion 98. In this event, the control valve 99 has been turned OFF, and thus the port A and the port B are connected to each other. The working oil in the first pump portion 95 flows into the reservoir 90 via the conduit 91b, the port A and the port B of the control valve 99, and the conduit 91a. The working oil in the second pump portion 98 is supplied to the cylinder 221 via the conduits 91d, 91c, 91e and the check valve 92b. It should be noted, however, that the amount of working oil supplied to the cylinder 221 is smaller than the amount of working oil discharged from the cylinder 221 when the pump signal Sₚ is turned OFF.

When the pump signal Sₚ is turned OFF, the solenoid portion 94 of the electromagnetic pump 93 allows the plunger 940 to be slid away from the first pump portion 95 and the second pump portion 98 using the spring force of the spring 942. In this event, the control valve 99 has been turned ON, and thus the port B and the port C are connected to each other. The working oil in the cylinder 221 is suctioned into the first pump portion 95 via the conduit 91e, the port C and the port B of the control valve 99, and the conduit 91b.

The function and the effect of the third embodiment will be described. With the third embodiment, during the feed operation, the cylinder 221 is supplied with working oil at a low pressure but at a high flow rate from the first pump portion 95 and supplied with working oil at a low flow rate but at a high pressure from the second pump portion 98 at the same timing. Thus, the feed operation can be performed rapidly to enhance the response of the friction clutch 53.

Although the drive force transfer device according to the present invention has been described above on the basis of the above embodiments, the present invention is not limited thereto. For example, although an electromagnetic pump (piston pump) is used in the first to third embodiments, other types of pumps such as a vane pump and a gear pump may also be used. The usage and the object of application of the drive force transfer device are also not limited to those described above.

What is clamed is:

1. A drive force transfer device comprising:
a first rotary member;
a second rotary member that is rotatable relative to the first rotary member,
a friction clutch that transfers a drive force of a drive source, and that has a plurality of first friction plates that are rotatable together with the first rotary member and a plurality of second friction plates that are rotatable together with the second rotary member;
a pressing member that receives a hydraulic pressure of working oil supplied to a cylinder to press the friction clutch;
a hydraulic circuit that supplies the cylinder with the working oil; and
a control device that controls the hydraulic circuit, wherein
the hydraulic circuit has a first pump that supplies the cylinder with the working oil, and a second pump that supplies the cylinder with the working oil at a pressure that is higher than that of the working oil supplied by the first pump.

2. The drive force transfer device according to claim 1, wherein
the first pump is capable of discharging the working oil at a flow rate that is higher than that of the working oil discharged by the second pump.

3. The drive force transfer device according to claim 1, wherein
the second pump is a piston pump that suctions and discharges the working oil through reciprocal motion of a piston disposed in a pump cylinder.

4. The drive force transfer device according to claim 1, wherein
the hydraulic circuit has a valve that relieves a pressure in the cylinder.

5. The drive force transfer device according to claim 1, wherein:
the first pump is driven by a first secondary drive source;
the second pump is driven by a second secondary drive source; and
the first secondary drive source and the second secondary drive source are controlled by the control device.

6. The drive force transfer device according to claim 4, wherein:
the first pump and the second pump are driven by a single secondary drive source;
the secondary drive source is controlled by the control device; and
the valve relieves the pressure in the cylinder and a pressure of the working oil discharged from the first pump.
